(19) United States
(12) Patent Application Publication
(10) Pub. No.: US 2021/0284361 A1
(43) Pub. Date: Sep. 16, 2021

(54) SYSTEMS AND METHODS FOR ATTITUDE CONTROL FOR A SATELLITE

(71) Applicant: Skeyeon, Inc., San Diego, CA (US)

(72) Inventors: Ronald E. Reedy, San Diego, CA (US); Thomas E. Schwartzentruber, San Diego, CA (US)

(21) Appl. No.: 16/928,401

(22) Filed: Jul. 14, 2020

Related U.S. Application Data
(60) Provisional application No. 62/875,061, filed on Jul. 17, 2019.

(51) Int. Cl. B64G 1/24; B64G 1/36; B64G 1/10

(52) U.S. Cl. CPC B64G 1/244; B64G 1/10; B64G 1/36

(57) ABSTRACT

Disclosed are systems and method for satellite attitude control, which includes two or more individual thruster unit (ITU) arranged at various locations about a body of the satellite, with each ITU oriented to provide thrust in a unique direction when fired. Additionally or alternatively, each ITU configured for independently controlled firing. In disclosed examples, one or more stabilization surfaces to compensate for changes in altitude of the satellite.

### CROSS REFERENCE TO RELATED APPLICATIONS

This application claims priority to U.S. Provisional application Ser. No. 62/875,061, entitled “Systems And Methods For Attitude Control For A Satellite,” filed Jul. 17, 2019, which is herein incorporated by reference in its entirety for all purposes.

### BACKGROUND

Orbiting satellites have numerous constraints placed on them, especially for size, mass and power consumption. Satellites are used for many reasons, including communications, earth observation, scientific research and others. Among their many system requirements, attitude control is one of the most important and difficult. A satellite stays in orbit in a perpetual state of free-fall, typically outside the atmosphere to avoid damage and drag from trace amounts of air particles. Orbiting satellites can experience torques on all three axes, thereby causing the vehicle to yaw, pitch and roll, relative to a defined coordinate system, such as the satellite's local horizon coordinate system.

With nothing to push against, attitude control, or maintaining orientation of a satellite on three axes, is typically achieved by reaction wheels, magnetorquers, thrusters, or other devices, with each approach having various disadvantages. Reaction wheels, basically spinning discs, create a torque by spinning their disc, with the satellite experiencing a counter-torque thanks to Newton's third law of motion (essentially that for each action there is an equal and opposite reaction). Reaction wheels, however, consume power, have substantial mass, require substantial volume, are expensive, and, as mechanical devices, are seen as reliability risks. Thrusters, used to create thrust through high to low pressure expansion, through chemical propulsion similar to rockets, or through propellant ionization and acceleration using electrical energy, require propellants. Each such strategy may require propellant that is eventually consumed, and each strategy requires power, volume, mass, and cost.

It is therefore desirable to create an attitude control system that can reduce size, mass and cost, while limiting the use of moving parts (e.g., a non-mechanical system).

### SUMMARY

The present disclosure relates, generally, to a satellite system at any orbiting altitude that utilizes at least one array of individual thrusters along with a control system that can create torque by controlled firing of these thrusters. In some examples, an array is defined by two or more individual thrusters, which may include a common thrust component (e.g., direction, magnitude, frequency, size, etc.). The disclosed system employs an array of thruster elements, which may be of any type or size as limited by the vehicle design. In the disclosed examples, a near earth orbit (NEO) vehicle as described in co-pending U.S. patent application Ser. No. 15/868,794, filed Jan. 11, 2018, entitled “System For Producing Remote Sensing Data From Near Earth Orbit”, which is incorporated by reference, employs individual thrusting units, or ITUs. Any type of thruster, such as plasma, ionic, metal plasma, chemical or mechanical, may be used to implement the current system. Any description of an ionic propulsion unit (IPU) or ionic thrust unit (ITU) is used interchangeably, and descriptions of such implementations are purely exemplary and not intended to be restrictive.

In some examples, especially at very low earth orbit of between 180 and 350 km, additional attitude control may be enhanced with and/or aided by aligned surfaces serving as passive or active aerodynamic control surfaces. As described below, a properly designed near earth orbit vehicle must generate thrust to overcome the vehicle's drag on a regular basis. As used herein, Near Earth Orbiters (NEOs) describe the system and its constituent vehicles (i.e., a “NEO satellite system”, “NEO vehicle” or a “NEO satellite”) that operate in stable orbits at 180-350 km (e.g., below a typical LEO). Therefore, it is another purpose of this invention to describe a satellite attitude control system based on orbital vehicles operating in stable Earth orbits at altitudes well below traditional satellites, specifically between approximately 180 and 350 km. It is a further purpose of this invention to describe a satellite attitude control system based on orbital vehicles operating in stable Earth orbits at altitudes well below conventional satellites, in particular, between approximately 180 and 350 km, in which the array of thrusters serve a dual purpose of drag reduction and/or attitude control, using a portion of the drag-reduction thrust for attitude control by selective firing of individual thrusters.

### BRIEF DESCRIPTION OF THE DRAWINGS

FIG. 1 shows an example prior art satellite.

FIG. 2 shows three axes of rotational control required to maintain the satellite's orientation relative to a fixed standard.

FIGS. 3a-3c show an exemplary design of a NEO satellite in accordance with aspects of this disclosure.

FIG. 4 shows an example NEO satellite system in accordance with aspects of this disclosure.

FIG. 5 shows an example ion engine with an array of individual thrusting units in accordance with aspects of this disclosure.

FIG. 6 shows another exemplary design of a NEO satellite in accordance with aspects of this disclosure.

FIG. 7 shows a side view of an example NEO satellite system subjected to one or more forces, in accordance with aspects of this disclosure.

FIG. 8 shows a top view of an example NEO satellite system subjected to one or more forces, in accordance with aspects of this disclosure.

FIG. 9 shows example graph of vehicle pitch data in accordance with aspects of this disclosure.

FIG. 10 shows example graph of vehicle yaw data in accordance with aspects of this disclosure.

FIG. 11 shows a perspective view of an example NEO satellite system with a variable center of mass, in accordance with aspects of this disclosure.

FIG. 12 shows example graph of vehicle pitch disturbance data with regard to a variable center of mass, in accordance with aspects of this disclosure.

FIG. 13 shows a front view of an example NEO satellite system experiencing a roll torque, in accordance with aspects of this disclosure.

FIGS. 14a and 14b show a perspective view of an example NEO satellite system subjected to a pitch moment, in accordance with aspects of this disclosure.

FIGS. 15a and 15b show a perspective view of an example NEO satellite system subjected to a yaw moment, in accordance with aspects of this disclosure.

FIG. 16 shows example graph of vehicle pitch and yaw related data with regard to angle of attack, in accordance with aspects of this disclosure.

FIG. 17 shows an example vehicle with exposed components in accordance with aspects of this disclosure.

The several figures provided here describe examples in accordance with aspects of this disclosure. The figures are representative of examples, and are not exhaustive of the possible embodiments or full extent of the capabilities of the concepts described herein. Where practicable and to enhance clarity, reference numerals are used in the several figures to represent the same features.

### DETAILED DESCRIPTION

This detailed embodiment is exemplary and not intended to restrict the invention to the details of the description. A person of ordinary skill will recognize that exemplary numerical values, shapes, altitudes, applications of any parameter or feature are used for the sole purpose of describing the invention and are not intended to be, nor should they be interpreted to be, limiting or restrictive.

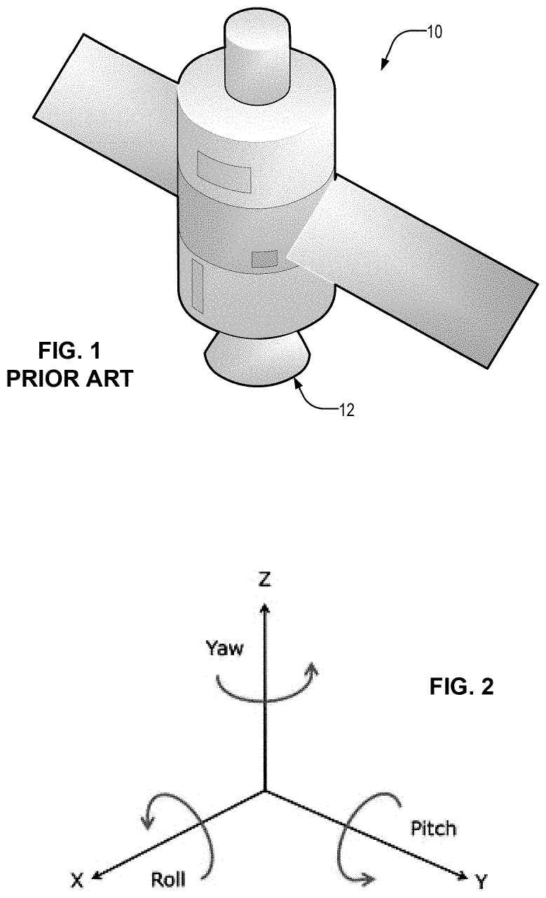

FIG. 1 depicts a prior art satellite 10, showing a single thruster 12, typically chemically powered, which requires an attitude control system (not shown) for maintaining the satellite's orientation. Two major issues with this type of satellite are a) the thruster 12 must be accurately aligned to the satellite to ensure the thrust aligns with the center of mass of the satellite and the desired direction of acceleration; and b) the satellite requires an attitude control system to ensure it is pointed in the correct direction for both proper acceleration and to keep antennae, or other components, aligned to their respective communications receivers and transmitters.

FIG. 2 shows the three axes of rotational control required to maintain the satellite's orientation relative to a fixed standard. In such a system, internal reaction wheels are often used to spin discs at increasing or decreasing rates to create torque around one axis. When the reaction wheels reach their rotational limit, additional elements or systems may be used to provide necessary torque options. Alternatively, large or multiple reaction wheels, or other torque control devices such as magnetorquers or other devices that utilize Earth's magnetic field, may be used that create torque sufficient to counteract a given anticipated amount of attitude error around a given axis. Employment of reaction wheels creates further issues, including high cost, substantial mass and volume, mechanical complexity with moving parts, and limited torque compensation.

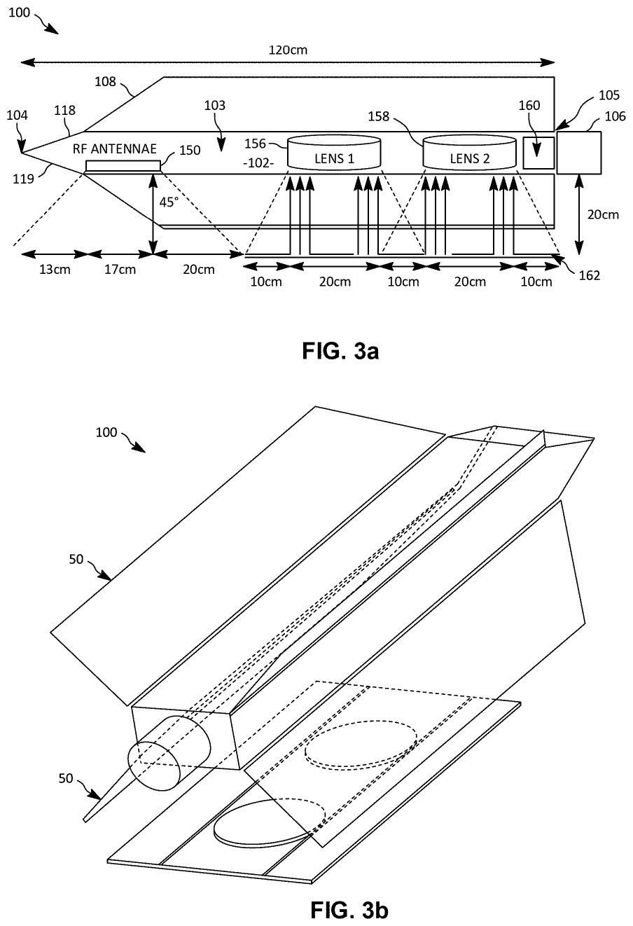

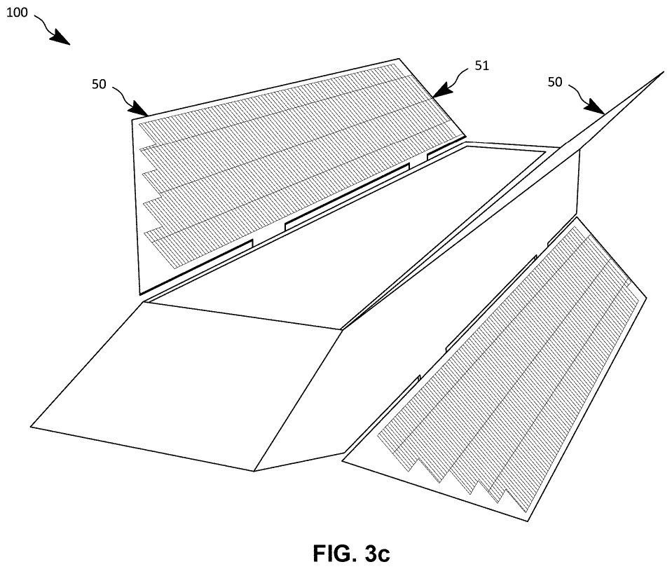

Traditional satellites operate well above the atmosphere, meaning there is little to no aerodynamic force available for attitude control. However, a new class of satellites, described in U.S. patent application Ser. No. 15/868,794, filed Jan. 11, 2018, entitled “System For Producing Remote Sensing Data From Near Earth Orbit,” incorporated herein by reference, is designed to operate at much lower altitudes, typically 180-350 km, at which the density of the atmosphere is sufficiently high to create substantial drag and to provide some degree of passive attitude control. As described in U.S. patent application Ser. No. 15/868,794, the near earth orbiter, or NEO, satellite requires thrust sufficient to compensate for drag. For this reason, surfaces (such as solar panels 51) may be aligned parallel to the direction of flight to minimize drag. In addition, during pitch or yaw or roll motion, such surfaces may now create a restoring moment (due to atmospheric drag) that may act to reduce the yaw, pitch, and/or roll motion. FIGS. 3a-3c show an exemplary design of a NEO satellite with an ion engine thruster. A single thruster must be aligned with the center of mass 103 of the NEO 102, as in FIG. 3a, in order to provide thrust without creating unintended torque.

As an example, FIG. 3a shows a cross-section of an example satellite illustrating various components and representative dimensions for the NEO vehicle 100, in accordance with aspects of this disclosure. For instance, the vehicle, from leading edge 104 to the far end 105 of the vehicle bus 102, is shown in the example of FIG. 3a as being approximately 120 cm long. Further, from the bottom edge of the engine 106 to the baffle 162 is approximately 20 cm. As shown if FIGS. 3a and 3b, the baffle 162 provides a filter for optical imaging systems 156, 158. Moreover, a wide-angle reception band of 45 degrees is illustrated for the RF antenna 150. Additionally, FIG. 3a shows a profile of the leading edge 104 and a top bevel 118 and a lower bevel 119.

One or more optical imaging systems/lenses 156,158 are also included (e.g., variable field of view, multispectral imaging, etc.). The lenses 156, 158 are configured to have a thickness sufficient to provide detailed imaging (e.g., a 1 m resolution at NEO altitudes) yet thin enough to fit within the vehicle bus 102, along with the various other components. A baffle 162 can be used to provide stability as well as filtering stray light effects from non-imaged sources. FIGS. 3b and 3c illustrate perspective views of an exemplary vehicle.

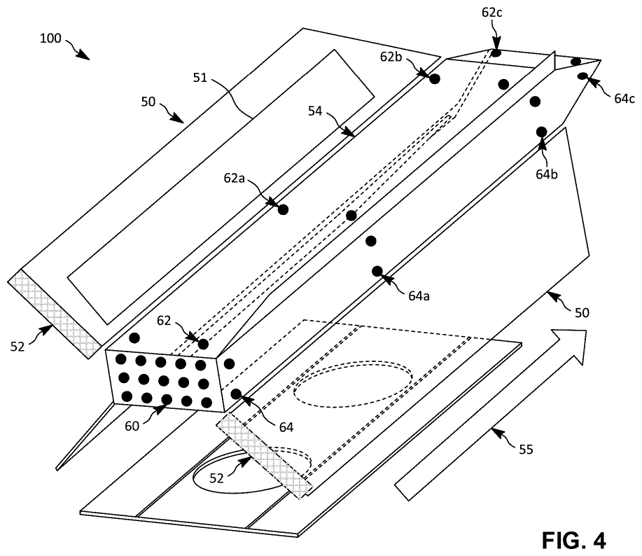

FIG. 4 shows a NEO satellite system 100 according to the current invention. As can be seen in FIG. 4, an array of individual thruster units 60-64, ITUs, are attached and are configured to provide both drag-compensating thrust and controlled torque. As shown in FIG. 4, many of the individual thruster units 60-64 are located off one or more of the axes and therefore will create a torque when activated individually. In the disclosed example, an array of ITUs 60 are arranged at the rear of the vehicle; one or more ITUs 62, 62a, 62b are arranged on the top surface 54; one or more ITUs 64, 64, 64 arranged on a lateral side of the vehicle; and one or more ITUs arranged on a bottom and/or far lateral side (not shown). Three independent axes, called roll, pitch and yaw, define the orientation of a vehicle (see, e.g., FIG. 2). As is well known, roll is an orientation rotating around the direction of motion; pitch is an orientation of the nose up or down with respect to the direction of motion; and yaw is an orientation clockwise or counter-clockwise away from the direction of motion. To maintain control of a vehicle, forces must be applied to create torques that adjust the orientation of that vehicle. For aircraft, control surfaces are typically used, but such surfaces are ineffective for most satellites due to the lack of sufficient atmospheric pressure.

FIG. 4 shows elements of control for a NEO vehicle comprising an array 60 of individual thrusters at the rear of the vehicle, each of which can be independently controlled and fired. For the purposes of clarity, each individual thruster unit 60-64 may be described as an ITU, but this is exemplary and a person of ordinary skill will understand that many types of thrusters such as ionic, electric, mechanical, metal plasma and/or chemical may be used. In the disclosed examples, the ITUs are metal plasma thrusters that are controlled as an array and are light weight for the same total thrust relative to other forms of electric propulsion. Placement of individual ITUs is relatively flexible in comparison to conventional thruster systems (see, e.g., the satellite 10 of FIG. 1). This flexibility, along with a control module's knowledge of placement and capability of each ITU, enables selective, independent and/or coordinated activation of one or more ITUs for fine control of attitude, as well as economical use of propellant within the array.

Although illustrated as an array and/or series of ITUs, propulsion that achieves the desired attitude adjustment can be implemented by an engine unit with an adjustable thrust vector, such as an adjustable nozzle. For example, a control module can direct the thrust vector or nozzle in a direction suitable to propel the vehicle in a desired direction, or an ionic nozzle can be controlled electrically to steer the ion beam. A person of ordinary skill will recognize that the NEO satellite depicted in FIG. 3 and FIG. 4 represents only an exemplary satellite system for an exemplary mission, and that the current invention is general to a wide range of satellite systems and missions.

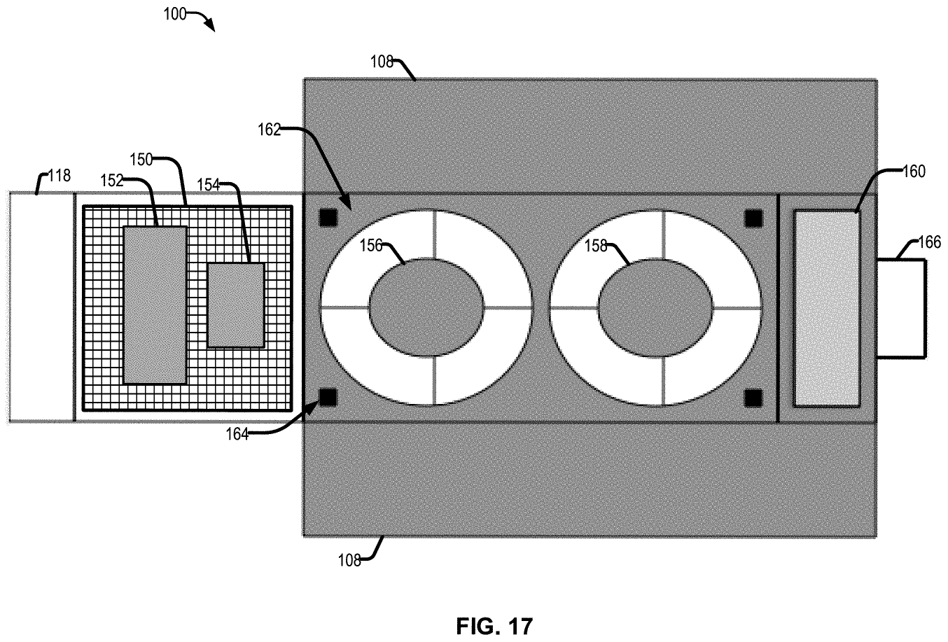

In a first example of the current invention, a control system independently fires a single or combination of ITUs as needed to maintain simultaneously both attitude control and orbital (e.g., altitude and velocity) control. The ITU firing instructions are calculated by a control module (such as computing platform 152 of FIG. 17) to provide sufficient attitude control as needed while also maintaining orbital control. For example, drag reduction may require 15 units of total thrust while pitch control may require 5 units of thrust from one or more rear ITUs 60 arranged in an upper row 66. In the example of FIG. 4, the control module may command the ITUs 60 in the upper row 66 to fire twice and the ITUs 60 arranged in a lower row 70 to fire once, thereby providing 15 units of forward thrust and 5 units of torque for pitch correction but using only a total of 15 units of ITU firing time. The current invention enables strategic placements of ITUs and controlled and selective firing sequences for the ITUs to provide simultaneous thrust and torque for yaw and/or pitch attitude control without any additional components, propellant, power and mass.

A person of ordinary skill will understand that at least two thrusters are employed for each independent axis of control (e.g., pitch, yaw and roll); however, any greater number of thrusters may be used in order to provide a desired outcome, such as when drag compensation is considered. Those skilled in the art will similarly understand that an odd number of thrusters along a given dimension of the satellite may result in thrusters along a midline 68 of the satellite. For instance, such thrusters may not create torque orthogonal to the midline 68, while an even number of thrusters along a given dimension may result in no thrusters along the midline of the satellite. Therefore, all such thrusters may create torque across midline 68. Different system requirements may be considered to determine the number of ITUs and their arrangement on the satellite.

Roll is a third dimension of attitude control that may not be correctable by ITUs aligned to the direction of motion, but can be controlled by one or more ITUs 62-64 along another surface of the satellite 102 in order to provide corrective roll torque. Such ITUs may not provide drag-reduction, so will add mass. Roll control may employ a subset of the ITUs 62-64 shown in FIG. 4. For example, with ITUs 62a (along with two additional ITUs located on a surface of the satellite bus opposite side panel 54) placed about the center of mass (CoM) of the vehicle, roll control may be achieved with the addition of a limited number of ITUs (e.g., four) beyond the 15 ITUs within the array 60, which are used for thrust, pitch, and/or yaw control. An alternative roll solution may employ a single-axis roll reaction wheel (as opposed to a three-axis system), and/or one or more deformable aerodynamic surfaces 52, further described below.

Although several disclosed examples reference a near earth orbit, the systems and principles of operation provided herein are applicable to any alternative orbit (e.g., greater than 350 km; greater than 500 km; etc.). For example, higher altitudes experience little or no drag, such that the disclosed systems and techniques may be implemented to provide attitude control for any satellite (even a satellite that does not experience atmospheric drag). In such a case, the disclosed systems and techniques could be used to provide attitude control and/or simultaneously alter the satellite orbit (e.g., by providing a “delta-V”=thrust in a particular direction relative to orbital motion, in order to alter a vehicle's orbit).

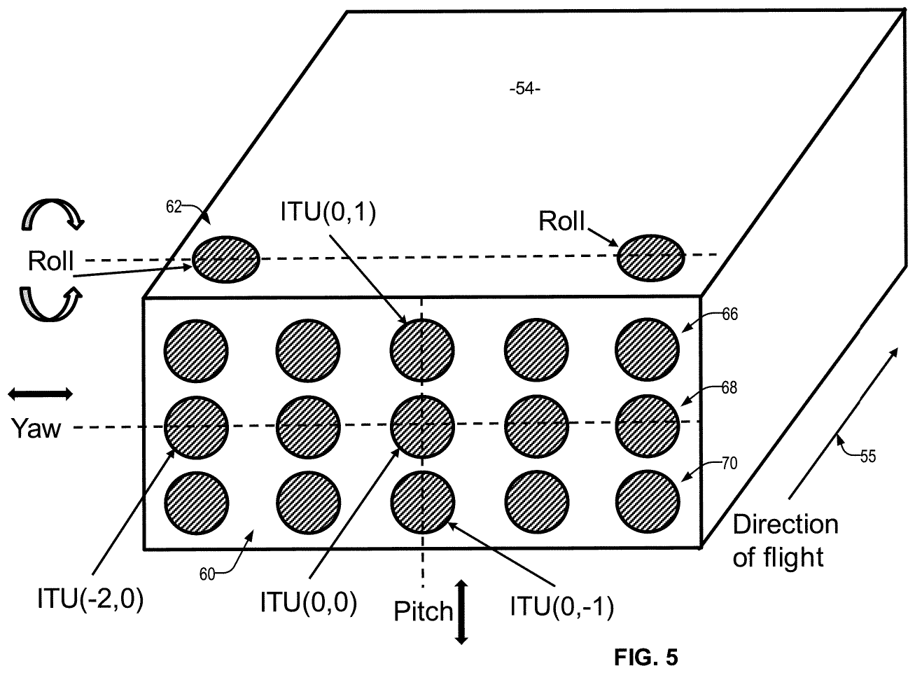

FIG. 5 shows an artistic rendition of an exemplary array 60 of fifteen ITUs. As stated, the array 60 shown in FIG. 5 is exemplary, and many other satellite geometries and ITU placements, such as periphery only, and/or corners only (such as ITUs 62 arranged on side panel 54) may be the proper design choice depending on the anticipated yaw, pitch, and roll corrections that would be encountered during a mission. Three combinations of thruster firings are disclosed that may control the three orientations of Roll, Pitch and Yaw. FIG. 5 shows, for example, that firing the row of thrusters above the Yaw line would cause the nose of the satellite to rotate downward (pitching motion) with minimal induced Yaw or Roll, thereby creating independent corrective torque around the pitch axis.

As one example, the array of ITUs 60 are arranged in a grid pattern, with the center ITU as ITU(0,0). ITU(−2,0) is therefore at the left edge of the exemplary 5×3 array and vertically in the center of the array. In some examples, the array may be an arrangement of ITUs in other configurations (e.g., in a variety of geometric arrangements, with variable spacing between different ITUs, on a single surface of the satellite, on two more or more surfaces of the satellite, etc.). In some examples, the array is defined by two or more ITUs, which may include a common thrust component (e.g., direction, magnitude, frequency, size, etc.). In some examples, one or more ITUs in the array may have varied and/or different thrust components (e.g., direction, magnitude, frequency, size, etc.). Further, the ITUs may be arranged on a common plane or surface, may be arranged about a complex geometric surface (e.g., spherical, multi-planar, pyramidal, etc.). ITU(−2,0) is therefore positioned to create yaw torque to orient the vehicle in a clockwise direction when fired. ITU(2,0), on the right side, would create yaw torque in a counterclockwise direction. However, ITU(−2,0) and ITU(2,0) would create no torque in the vertical (pitch) direction and no roll torque.

In addition, exemplary ITU(0,1) located in the middle of the vehicle at the top of the array would create torque to pitch the vehicle downward but no torque for yaw or roll. As a person of ordinary skill will understand, individual ITU's off both of the centerlines would create torque in both pitch and yaw. It should also be apparent that the farther off-axis a given ITU is placed, the greater the torque in that direction for each element of thrust. For example, when two or more ITUs are fired in symmetric combination about the center of mass of the satellite, such as firing ITU(0,1) and ITU(0,−1) simultaneously, minimal net torque would be created, only thrust. Similarly, any ITU on neither the centerline nor the middle of the array, such as ITU(1,1), will create torque in both pitch and yaw unless compensated by ITU(−1,−1). In all cases, each ITU will provide thrust (including ITU(0,0)) in addition to torque (excepting ITU(0,0)), and the off center array allows the attitude control logic to adjust any combination of off center firing, relative to the center of mass, to achieve a desired net torque, within the limits of the thrust magnitude. One aspect of the disclosed system is that the array of ITUs 60, when control is coordinated, serves to control both net thrust and attitude without additional propellant, mass, power, volume, and/or cost.

As another element of attitude control, roll control will be described for the first example of the current invention. In one exemplary solution, one or more ITU thrusters in the rearward ITU array 60 may be aligned to provide thrust at an angle relative to the direction of motion. As shown in FIG. 5, exemplary ITUs (2,1), (2,−1), (−2,1) and (−2,−1) could be aligned at +/−45 degrees relative to the centerline and therefore be able to provide torque for roll control. It is understood that the combination of firings needed for either clockwise or counterclockwise roll control will depend on the amount of roll torque needed. Accordingly, additional ITUs could be aligned at the same or different angles, creating additional torque capabilities as needed to maintain control. As a person of ordinary skill will understand, the off-axis ITUs will provide reduced thrust in the direction of thrust. For example, net thrust for four ITUs would be reduced (e.g., by about 30%), but the satellite 100 would gain a three-axis attitude control system.

Another exemplary roll control system shown in FIG. 5 shows additional exemplary ITUs 62 located on the top (and bottom, not shown) of the vehicle, in this example at each corner, in addition to the array 60 at the stern of the vehicle. Such ITUs may be located at each corner or along an edge, including at the optimum point of the CoM of the satellite along the roll axis to maximize roll torque while avoiding inducing pitch and/or yaw torque. Other locations are workable since the array (60) can compensate for any induced yaw or pitch from an off-center roll thruster, such as locations of 62a and 62b shown in FIG. 4 of the vehicle, typically pointing their thrust orthogonal to the direction of motion. These ITUs 62 would have maximum torque in pitch, roll, or yaw per unit of thrust since their direction of thrust is at 90 degrees to the direction of motion 55 and at a maximum distance from the center of rotation. However, such ITUs would be useful only for attitude adjustment and provide no net thrust.

The advantage of employing multiple ITUs is that each individual ITU can be smaller and/or provide lower thrust, compared to a single, large thruster. In this manner, the aggregate thrust from firing a majority or all of the ITUs can be high, but individual ITU provides a subset of the aggregate thrust by providing impulse bits (e.g., small thrust bursts). Accordingly, the resulting torques from each individual ITU can be relatively small. Furthermore, the frequency of ITU firing can be high, firing even more than once per second, for example. The combination of small impulse bits and high frequency of firing can provide precise moments and torques for fine attitude control. The location, orientation, thrust magnitude, and firing frequency of each ITU or each array of ITUs may be controlled to provide the desired satellite angular rates of motion, slew rates, and/or overall attitude control (e.g., based on the satellite's moments of inertia). Advantageously, large numbers of small ITUs can be more readily mass produced and therefore could be produced at a lower cost than a larger thruster.

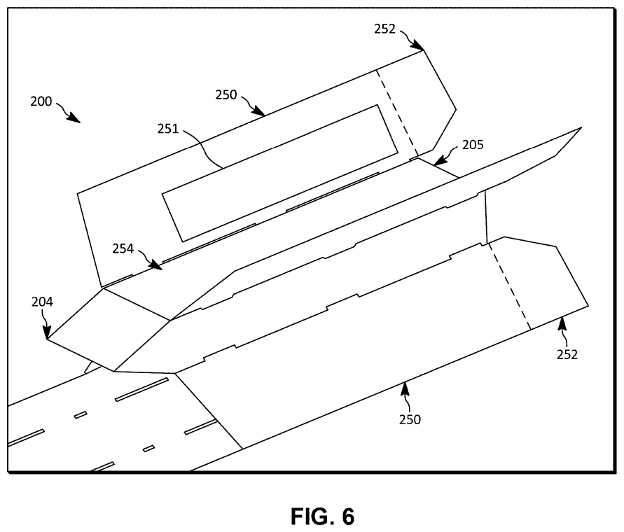

In another example, surfaces of a satellite, such as seen on the exemplary NEO vehicle 200 in FIG. 6, may provide attitude control due to impact of trace amounts of atmospheric particles found at altitudes of 180-350 km. Nominally, when operating at low altitudes, all surfaces of the NEO are aligned to the direction of flight to minimize the drag force created by particle impacts, but also to create forces when they rotate off axis. In some examples, panels 250 are oriented to provide stability. In some additional or alternative examples, moveable surfaces or roll control flaps 252 may extend from one or more of the panels 250. In some examples, if the NEO vehicle nose were to pitch down, the top surfaces 254 of the body of the NEO would be impacted by an increased number of air particles. If the average center of this aerodynamic force lies behind the satellite center of mass (e.g., closer to the rear of the vehicle 205 than the front edge 204), a corrective torque will be produced to drive the back of the vehicle down and the front edge 204 back up, therefore correcting the pitch. Similar corrective action would occur in a yaw condition. Roll control based on surface deflection of air particles is discussed, below.

In some examples, roll, pitch and yaw control are provided by passive alignment of panels 250 (or other passive surfaces, e.g. top surface 254). Additionally, moveable surface panels may be attached to the passive surfaces to provide active control without firing of any ITUs (e.g., roll control panels 252). As described above, the presence of atmospheric particles colliding with any vehicle surface can apply a net corrective force, provided that the vehicle surfaces and the vehicle center of mass and/or mass distribution are optimized. It is noted that this effect could be further controlled if the surface material is as described in U.S. patent application Ser. No. 15/881,417, filed Jan. 26, 2018, entitled “Atomic Oxygen-Resistant, Low Drag Coatings and Materials,” and creates partial specular scattering of the incoming particles.

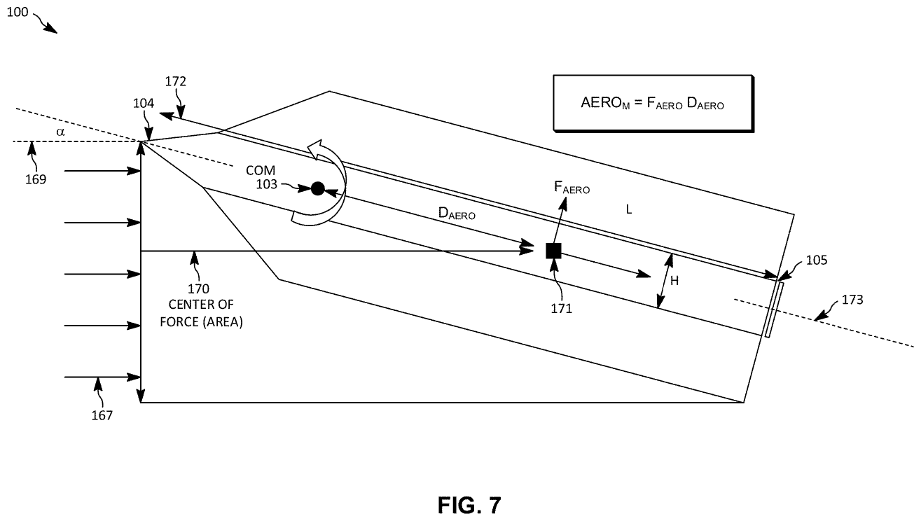

To be clear, diffuse scattering would cause drag on the exposed surface, and thereby create corrective torque, but with less effect than specular scattering, as discussed below. With diffuse scattering, the particles are decelerated and re-emitted at low (thermal) energy and momentum, and in a hemispheric pattern (as shown in FIGS. 6-7 of U.S. patent application Ser. No. 15/881,417). Diffuse scattering, specular scattering, and partial specular reflecting cause drag on the exposed surfaces. These aerodynamic forces create torques on the vehicle that can be exploited for passive stability and/or control.

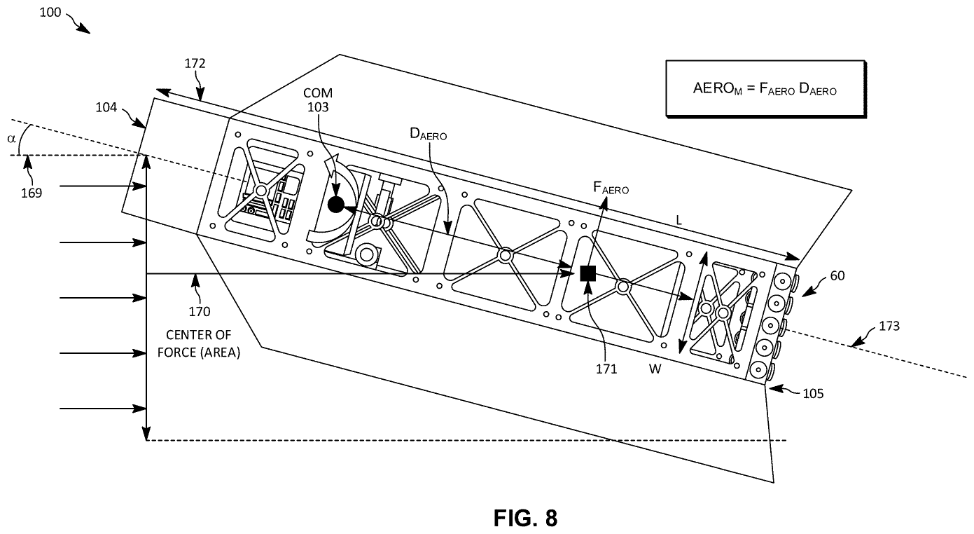

In an example depicted in FIG. 7, the pitch moment (and torque) created about the center of mass 103 is proportional to the component of force acting in the counterclockwise direction (F_{AERO}) multiplied by the distance (D_{AERO}) between the center of force 171 and the center of mass 103. For a specific orbit altitude, the component of force (F_{AERO}) changes in proportion to the coefficient of drag and also changes strongly with the current pitch angle (α) relative to the angle of attack 169 of incoming particles 167. For example, the changes may be proportional to [sin α]². As depicted in FIG. 8, the yaw moment (and torque) created about the center of mass 103 has the same dependence on F_{AERO}, D_{AERO}, and the same dependence on the yaw angle (also denoted by a).

In general, the magnitude of the angle of attack deviation 169, the angular rates, and the period of oscillation are determined, in part, by a ballistic coefficient (BC). The BC is most commonly defined as the ratio between the mass of the object (M) and the product of the drag coefficient (CD) and the cross-sectional area (A), as provided in equation 1:

$$B C = \frac{M}{{C}_{D} \times A}$$

For free-molecular flow conditions experienced in low earth orbit (e.g., greater than approximately 80 km), CD is approximately constant, typically ranging between 2.0-2.2. Therefore, objects with relatively low mass and/or relatively large cross-sectional area have a relatively low BC value, which corresponds to lower passive stability including larger angle errors, larger angular rates, and shorter periods of oscillation. Objects with high mass, and/or small cross-sectional area (such as the relatively low cross-sectional area of the exemplary satellite) have a high BC value, which corresponds to higher passive stability including smaller angle errors, smaller angular rates, and/or longer periods of oscillation.

The BC can be further increased through the use of low drag materials (e.g., partially specular reflecting materials as described in U.S. patent application Ser. No. 15/881,417, filed Jan. 26, 2018, entitled “Atomic Oxygen-Resistant, Low Drag Coatings and Materials”), since such materials can lower the CD value by a factor of two, and therefore increase the BC value by a factor of two, leading to a higher degree of passive stability for the same vehicle geometry.

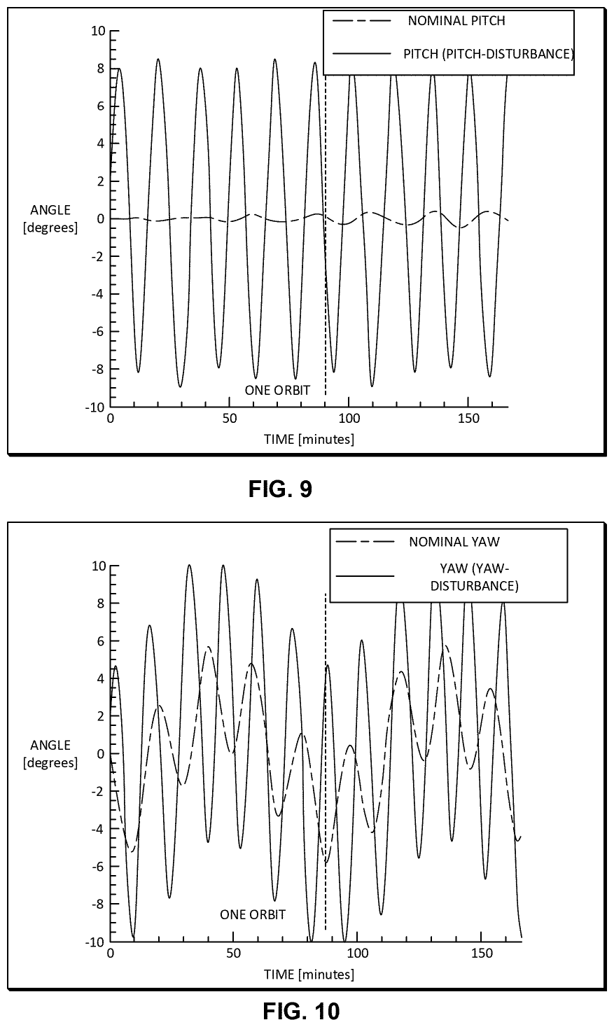

The resulting dynamics of an exemplary satellite are depicted in FIG. 9 for pitch and FIG. 10 for yaw, with both figures showing simulation results when relatively slight disturbances and relatively large disturbances are simulated, respectively. The change in pitch and yaw angles of the exemplary satellite, in orbit at approximately 250 km altitude, are shown as a function of time in FIGS. 9 and 10, in comparison to nominal pitch and nominal yaw, respectively. Since each orbit takes approximately 90 minutes, approximately five pitch and yaw oscillations occur in each orbit. FIG. 9 shows that with low levels of disturbance (e.g., slight or nominal pitch disturbances, less than about 0.05 degrees per second) to the satellite attitude, the maximum pitch angle is maintained to less than one degree by the passive aerodynamic stability. When the disturbance level is increased (e.g., large or significant pitch disturbances, greater than about 0.05 degrees per second), the maximum pitch angle increases, but remains bounded below eight degrees by the passive aerodynamic stability. Possible sources of disturbances may include, but are not limited to, temperature transitions from day to night and vice versa, orbit variations, satellite geometry, moments of inertia, location of a center of mass, for example.

Without any aerodynamic stability, and with no additional attitude control system, any disturbances would result in uncontrolled tumbling of the satellite. Similarly, FIG. 10 shows that passive aerodynamic stability maintains the maximum yaw angle below six degrees when slight disturbances are present, and below ten degrees when larger disturbances are present. As described previously, the aerodynamic correcting moment, or torque, is strongly dependent on the instantaneous pitch and/or yaw angle. For this reason, there is some angle at which the aerodynamic moments and torques are great enough to reverse the pitch and yaw direction and bring them back towards zero angle of attack. This creates an oscillating motion as seen in both FIGS. 9 and 10.

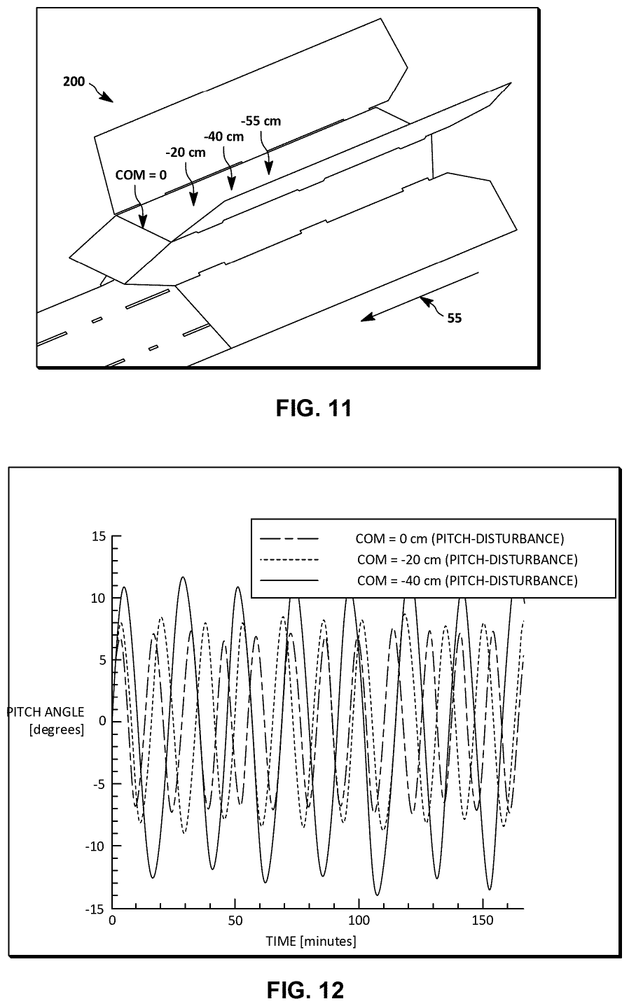

FIG. 11 shows how the location of the satellite center of mass (COM) affects the passive aerodynamic stability. In aircraft dynamics, the center of aerodynamic force (also referred to as the center of pressure for aircraft technology) is to be located behind (e.g., downstream of) the center of mass in order to be passively stabilized. As shown in the graph of FIG. 12, for the exemplary geometry of satellite 200, as the center of mass is moved farther downstream, the maximum pitch angles increase. For example, when the center of mass becomes too close to the center of aerodynamic force (e.g., at the −55 cm COM location), or actually becomes located downstream of the center of force, the satellite begins tumbling (e.g., spinning completely around in yaw and/or pitch directions).

Furthermore, the overall area of the aerodynamic surfaces can be increased or decreased in order to alter the overall aerodynamic force from interactions with atmospheric particles and/or the location of the center of force compared to the center of mass. Generally, increasing the area of the surfaces and positioning the surface area farther downstream of the center of mass, both act to reduce the maximum pitch and yaw angles.

In general, the orbit altitude (e.g., which is directly related to atmospheric density and therefore the magnitude of aerodynamic force from atmospheric particle interactions), the area of the satellite surfaces, the orientation of the surfaces relative to the direction of flight, the scattering behavior of particles as they interact with the surfaces, and/or the location of the center of aerodynamic force relative to the center of mass of the satellite, among other variables and parameters, can all be optimized to limit the range of attitude angle errors. These factors may also be measured and/or calculated and included in programming of the attitude control system to properly implement the current invention. A person of ordinary skill can recognize that the exemplary satellite configuration and orbital conditions described represent a few of several features that can be optimized, and such a passive aerodynamic stability approach can be applied at any altitude where these parameters can be optimized to produce angles within a desired accuracy for the function of the satellite.

The control effects of these surfaces may be insufficient to completely control orientation of a NEO satellite on all three axes. In addition, these surfaces may not be perfectly aligned throughout the vehicle's lifetime. Additional factors that may influence the need for additional attitude control include the following: manufacturing tolerances, collisions with space junk, flying at higher altitudes where the surfaces are insufficient for corrective forces, an amount of weight shifting during launch, deployment, the gradual depletion of propellant mass throughout the satellite lifetime, associated changes in the center of mass, uneven depletion of the ITUs, and unequal thrust from the ITUs. Additionally, these control surfaces may provide corrective torque, but may also increase drag when the NEO vehicle is not aligned to the direction of motion 55. Also, an ITU array 60 can provide a complementary function to the surface control effects, by adding thrust control in addition to the passive aerodynamic control.

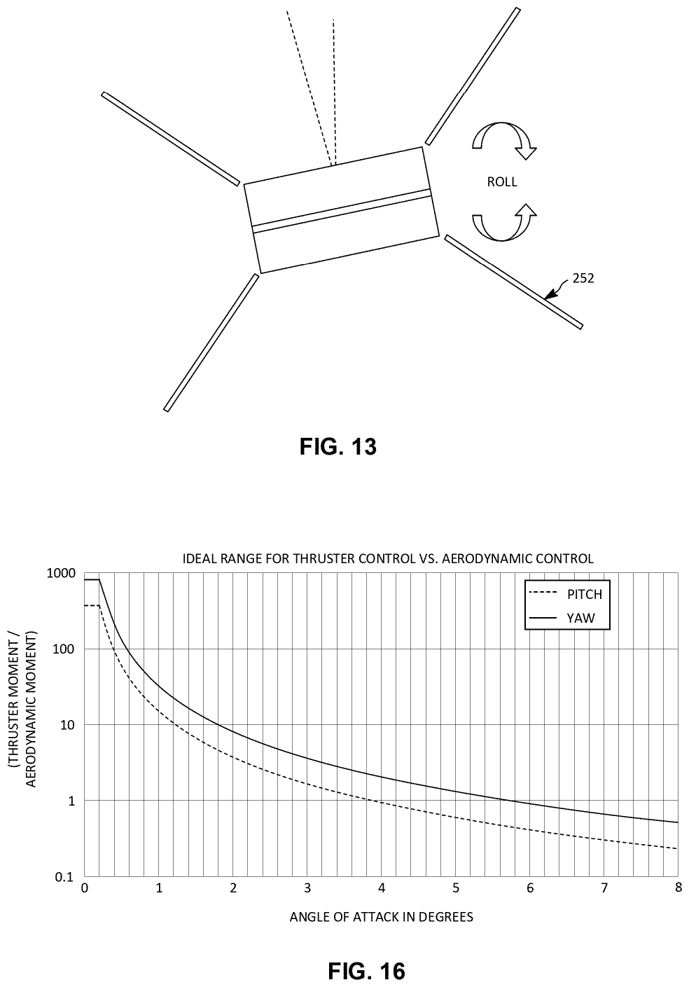

Roll, however, would not experience a corrective force from the aligned surfaces in the exemplary satellite configuration shown in FIGS. 7 and 13, unless moveable surfaces 52, 252 were added, for example to the panels 50 as shown in FIG. 4 and panels 250 of FIG. 6 (which may include solar cells or paneling 51, 251). These moveable surfaces 52 would have the same effect as an aileron on an aircraft, but not based on laminar flow or aerodynamics as apply to ailerons, but rather based on free-molecular aerodynamics. For the exemplary moveable or active control surfaces 52 shown in FIG. 4 and moveable surfaces 252 of FIG. 6, the attitude control system would rotate the moveable surfaces 52, 252 off the axis of flight to intercept atomic particles found at the altitudes described above and to deflect them.

Due to the low atmospheric pressure at the described altitudes, these air particles have such great mean distance between collisions that they behave ballistically as individual particles (referred to as free-molecular aerodynamics), not as waves or combined motion as occurs at much lower altitudes where aircraft operate (and where the much higher pressure results in laminar flow or turbulent flow). In one example, these surfaces comprise materials that induce diffuse and/or specular reflection of the incident particles which results in a force when each particle's path is deflected away from the direction of motion 55 of the NEO satellite. This force, in turn, may create a rotational torque on the satellite, and therefore a rolling motion, as desired. Two such moveable surfaces 52 are shown in FIG. 4 to double the rolling torque but it is understood that many configurations, locations and/or functional control devices may be used. For example, moveable surfaces may be included on the leading edge of the main aligned surfaces (solar panels 50 in FIG. 4); and/or a mechanism may be included in these surfaces to change their shape to deflect incident particles. Additionally, yaw and pitch motion becomes coupled to, and can induce, roll motion as angles increase. Under some circumstances, if yaw and pitch can be controlled then some amount of roll control could also be exerted.

In a third example of the disclosed satellite, when operating at low altitudes where atmospheric drag is present, the passive aerodynamic stability described above can be augmented by an active control system. For example, the active control system is configured to selectively fire an ITU or one or more combinations of ITUs to simultaneously provide drag compensation thrust and/or provide moments or torque for attitude control. For example, the ITU thruster array 60 shown in FIGS. 4 and 5, along with the passive aerodynamic control surfaces, may provide sufficient attitude control, while also providing forward thrust to compensate drag as needed. As illustrated in the figures, the ITUs in the array 60 provide the thrust needed to counteract drag and they serve a second purpose of providing torque to affect the pitch, yaw, and/or roll of the vehicle. It is a function of the control system to calculate how much torque is required in a given orientation and fire the appropriate ITU(s) 60-64 while also considering how much thrust is needed to counteract drag.

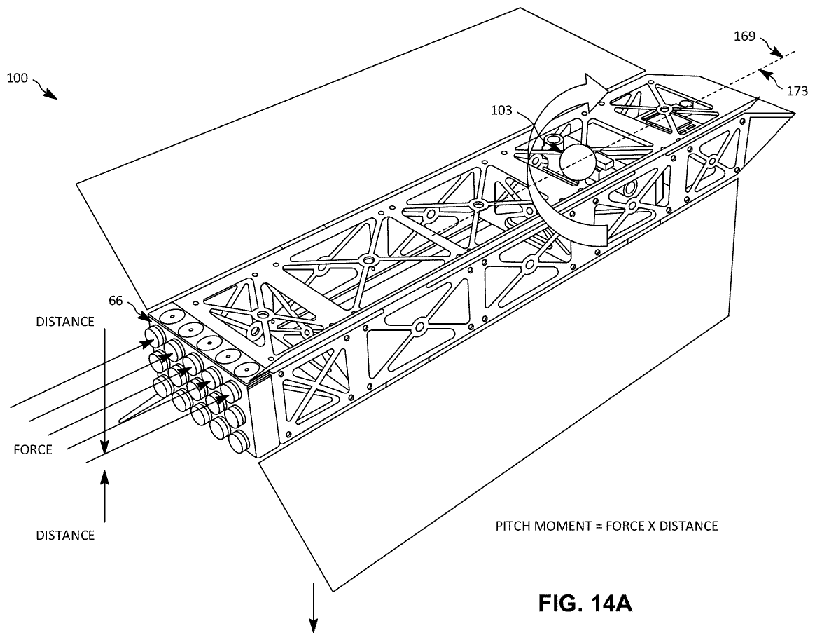

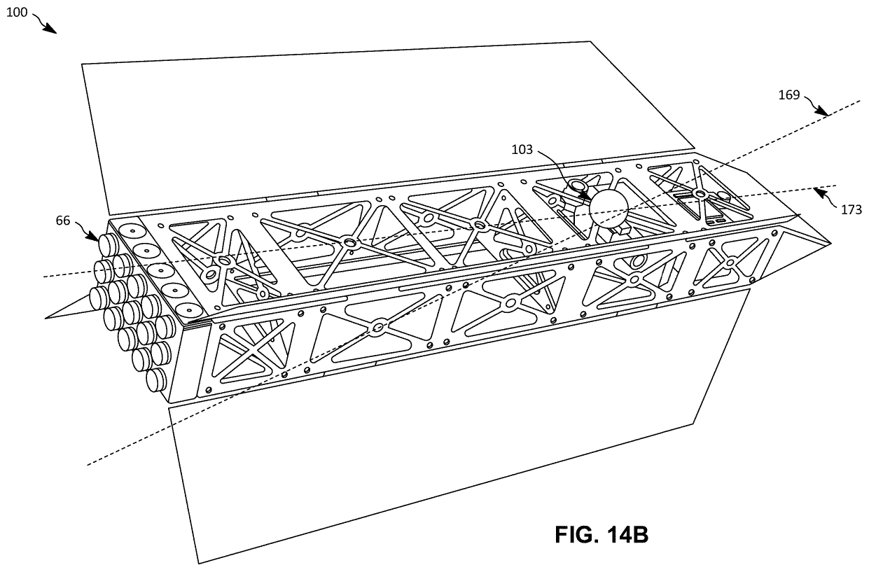

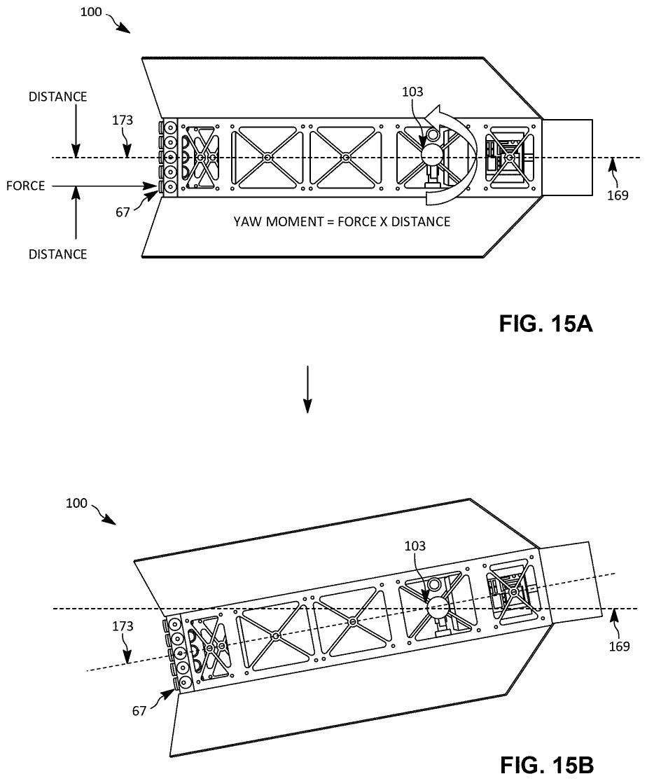

If a satellite requires thrust to compensate for atmospheric drag, then this thrust could be generated by one or more ITUs firing along the direction of flight, or symmetrically about the direction of flight, such that the overall thrust vector goes through the spacecraft center of mass in the direction of flight. In this case, no moments or torques (e.g., in yaw, pitch, or roll) are created. The disclosed satellite allows a number of ITUs (e.g., such as an array of ITUs), to be fired asymmetrically, so that thrust vector does not pass through the center of mass, in order to produce moments or torques that provide attitude control. FIGS. 14a and 14b, and FIGS. 15a and 15b show exemplary arrangements of ITUs on an exemplary satellite 100, where the ITUs can provide thrust to simultaneously compensate for drag and provide attitude control. The moment or torque is proportional to the thrust force multiplied by the distance between the ITU thrust location and the center of mass 103, along the yaw or pitch axis. Therefore, the moment or torque created by each ITU increases with its distance from the center of mass 103 along each axis direction (e.g., central axis 173). At the same time increasing this distance may result in an increase in the cross-sectional area of the satellite 100, which in-turn will increase atmospheric drag. Therefore, the satellite 100 illustrated in FIGS. 14a and 14b, and FIGS. 15a and 15b represent an exemplary arrangement. The degree of ITU control and total cross-sectional area can be modified to ensure each variable is optimized for different satellite geometries and orbit conditions.

In some examples, ITUs could be placed on the edges of solar panels, and/or on other extendable surfaces, beams, or other structures, to increase the control torques while minimizing the added cross-sectional area.

According to some examples of the disclosed satellite, the ITUs may be controlled to fire asymmetrically (e.g., consistently, periodically, on an as-needed basis, etc.), where only a subset of the ITUs within array 60 (or elsewhere) are fired at one time. In this case, in order to still obtain the same overall drag compensation (e.g., the thrust component in the flight direction), the firing frequency (e.g., the duty cycle) of the one or more ITUs may increase. For example, as shown in FIG. 14a, if only the top row 66 of five ITUs (of the total 15 ITUs in array 60) fire for a given period of time (e.g., in order to produce a pitching torque), then they must fire more frequently (e.g., 15/5=3, or three times more frequently) than if the full array of all 15 ITUs were being fired, in order to obtain the same level of drag reduction. The result is to pitch the nose of the vehicle downward, such that the central axis 173 deviates from the direction of flight 169 by a desired amount, as shown in FIG. 14b.

In some additional or alternative examples, each ITU may fire at a variety of levels, each level corresponding to a different magnitude of thrust. In other words, a first firing impulse may generate a greater amount of thrust than a second firing impulse. An increase amount of thrust may correspond to a greater amount of propellant used per impulse. Similar to the firing frequency and/or the selective firing of various ITUs, the level of each impulse and/or amount of resulting thrust can be determined based on application of one or more algorithms, to ensure a desired attitude adjustment, movement, and/or drag compensation. In some examples, an array is defined by two or more individual thrusters, which may include a common thrust component (e.g., direction, magnitude, frequency, size, etc.).

In another example, as shown in FIG. 15a, if only the left row 67 of three ITUs were fired for a given period of time, then they must fire more frequently (e.g., 15/3=5, or five times more frequently) than if all 15 ITUs were being fired, in order to obtain the same level of drag compensation. A person of ordinary skill can see there are many combinations and permutations for ITU placement and/or firing sequences and/or duty cycles that may be possible in order to obtain the desired drag compensation and produce desired moments and torques for attitude control.

A controlling system that senses the satellite's current attitude (e.g., using star trackers, gyros, or other attitude sensing devises or systems), could determine and execute optimized ITU firing arrangements and duty cycles to achieve the desired attitude control and drag compensation. Such a control system could also ensure that, over the lifetime of the satellite mission, the ITUs use the same average amount of propellant, possibly by ensuring the same number of individual firing events for each ITU.

If the entire set of ITUs must fire at their maximum engineered duty cycle in order to produce enough forward thrust to compensate for atmospheric drag, then the system of ITUs may not be capable of also firing asymmetrically to control the satellite while compensating for drag. The engineered duty cycle and magnitude of each individual thrust impulse bit can therefore be optimized for a given satellite and a given orbital altitude to enable increased duty cycle operation and therefore attitude control as described previously.

According to some examples of the disclosed satellite, it is possible to carry the propellant primarily intended to compensate for atmospheric drag and still use/reuse this propellant and associated thrust for attitude control as well. In this case, the thrust available from the ITUs for attitude control may be directly related to the level of atmospheric drag and therefore directly related to the aerodynamic moments and torques that provide passive stability and attitude control. For example, FIG. 16 plots the ratio of the ITU thrust moment to the aerodynamic moment for a range of angles of attack in both pitch and yaw. As shown in FIG. 16, at some angle of pitch or yaw, the moment created by asymmetric firing of the ITUs will equal the aerodynamic moment created by the satellite surfaces at that same angle of pitch or yaw (resulting in a ratio equal to 1). At lower angles of pitch and yaw, where the aerodynamic moments and torques are low, the moments or torques produced by asymmetric firing of the ITUs can be substantially larger (e.g., more than 10 times larger) than the aerodynamic forces. Asymmetric ITU firing and control torques can be produced at any point (any angle) during the period of pitch or yaw motion, unlike the aerodynamic torques that only become sizeable, and therefore impactful, at large pitch or yaw angles. Therefore, asymmetric ITU firing can be performed at lower angles of pitch or yaw and can precisely control the satellite attitude to low pitch and yaw angles compared to the use of passive aerodynamic control alone.

Aerodynamic corrective forces are proportional to the angle of attack (e.g., pitch or yaw), while thrust-based corrective torque are constant with angle of attack. Therefore, as a person of ordinary skill will understand, thrust-based corrective torque may be more effective than aerodynamic corrective torque at small angles of attack. However, the reverse may be true at large angles of attack

In some cases, extra propellant, relative to that required to compensate for drag, may be carried and used by the ITUs. Such a strategy may be used to gain larger torques from the asymmetric firing of the ITUs. Depending on the ITU arrangement, using more thrust than required for drag compensation, even if fired asymmetrically, may result in a net force (thrust greater than drag) and therefore a change in orbit. The vehicle may accelerate beyond the amount needed to maintain constant velocity and therefore would move to a different orbital configuration (for example, a higher or lower or eccentric orbit). Since this may be undesirable, the attitude control system may be configured to create an intentional misalignment to the direction of motion, for example create a minor downward pitch of the vehicle, to create additional drag. Alternatively, one or more ITUs 62c, 64c could be placed on the front of the vehicle, creating thrust in a direction opposite to the direction of orbital motion, in order to produce the desired amount of net thrust in the direction of orbital motion and/or a desired torque to effect attitude control. In some cases, the ability to change orbit (by an overall delta-V thrust) may be desirable. A person of ordinary skill will recognize that a wide range of ITU arrangements, thrust levels, thrust vector directions, duty cycles and firing frequencies, are allowed so that the attitude control logic can select any sub-combination of ITUs and firing times to achieve the desired overall thrust while maintaining attitude stability.

A person of ordinary skill will recognize in the exemplary descriptions above that a complete, three-axis attitude control system has been described. In some cases, due to orbital mechanics and vehicle design, it may be possible to utilize only one or two axes of thrust-based control in addition to vehicle design and orbital mechanics. The same person will recognize that the current invention may eliminate a requirement for reaction wheels or other attitude control elements, or for any other type of conventional attitude control, thereby saving cost, size and mass while increasing reliability through elimination or reduction of moving parts. The same person will recognize that attitude control may also be used to orient a satellite to a new direction, for example to align a camera or sensor to a new direction, or to rock a satellite back and forth to provide a scan of photos, thereby increasing potential areas of coverage, and that thrust additions can be combined with attitude correction particularly for pitch and yaw.

A properly designed NEO satellite may employ a certain total thrust to compensate drag, T_{drag}, for a designed satellite orbit lifetime; and that a certain amount of thrust, T_{attitude}, may be needed for active attitude control from thrusters. In some disclosed examples, the total thrust provided on a NEO satellite with the disclosed ITU arrangements and/or controls, Tₜₒₜₐₗ, is less than the sum of T_{drag},+T_{attitude}, as a result of selective controlled firing of ITUs in the array of ITUs and/or arranged along a surface of the satellite. For example, Tₜₒₜₐₗ may equal T_{drag} or exceed T_{drag} by for example 10%, 20% or more.

FIG. 17 shows a view of an example NEO vehicle 100 with the bottom surface removed to expose various components therein. As shown in FIG. 17, a radio frequency antenna 150 (e.g., a phased array) can be included. A computing platform 152 can include a processor, memory storage, and/or various sensor types. Attitude control gyroscopes and/or reaction wheels can be included. For example, data on attitude control can be provided to the computing platform 152, where the processor may calculate the amount of change required to maintain a particular orientation. Information regarding the location of each ITU is also provided to the computing platform 152 which provides the attitude control logic, such that it is determined which ITU to activate and for how long to achieve a desired orientation.

In some examples, a present and desired attitude can be compared and any adjustments can be implemented by the computing platform 152. For example, based on sensor data, the computing platform 152 can determine spatial information indicative of a current altitude of the satellite, an orientation of the satellite relative to a terrestrial surface, and a position of the satellite relative to other satellites or the stars above (via an imaging system oriented toward the stars). This data can be compared against a desired altitude, orientation or position. If the computing platform 152 determines an adjustment is needed, the engine 106 is controlled to generate thrust sufficient to achieve the desired altitude, orientation or position. Current spatial orientation is fed to the computing platform and attitude control logic 152 using methods known in the art, for example by fixing the orientation of the satellite relative to the visible star field.

A battery 154 or other storage system (e.g., capacitor, etc.) can be used to store power collected by solar panels in order to, for example, power the various components and the engine 106 of the NEO vehicle 100. Additional and alternative components may be included in the NEO vehicle 100, such as radar or radio components, sensors, electronics bays for electronics and control circuitry, cooling, navigation, attitude control, and other componentry, depending on the conditions of the orbiting environment (e.g., air particle density), the particular application of the satellite (e.g., optical imaging, thermal imaging, radar imaging, other types of remote earth sensor data collection, telecommunications transceiver, scientific research etc.), for instance. In some examples, the system can include one or more passive and/or active systems to manage thermal changes, due to operation of the components themselves, in response to environmental conditions, etc. The computing platform 152 can be configured to adjust the duty cycle of one or more components, transfer power storage and/or use from a given set of batteries to another, or another suitable measure designed to limit overheating within the NEO vehicle 100.

What is claimed is:

1. A satellite comprising at least two individual thruster units (ITUs), the ITUs being configured for controlled firing to provide attitude control and drag compensation, wherein at least two ITUs of the plurality of ITUs are arranged in an array.

2. The satellite defined in claim 1, wherein the at least two ITUs are arranged in an array of ITUs.

3. The satellite defined in claim 2, wherein the array of at least two ITUs is arranged as a planar array of ITUs.

4. The satellite defined in claim 1, wherein the at least two ITUs are configured to fire to provide an impulse to provide attitude control and drag compensation.

5. The satellite defined in claim 4, further comprising a control circuitry to receive data corresponding to one or more forces acting on the satellite, the control circuitry to control at the at least two ITUs to fire to provide the impulse to correct pitch attitude or drag on the satellite based on the one or more forces.

6. The satellite defined in claim 5, wherein the control circuitry is further configured to control each ITU independently.

7. The satellite defined in claim 1, wherein the at least two ITUs are further configured to provide yaw attitude control and drag compensation.

8. The satellite defined in claim 1, wherein the at least two ITUs are further configured to provide pitch attitude control and drag compensation.

9. The satellite defined in claim 1, wherein at the at least one of the at least two ITUs is configured to provide torque about the center of mass.

10. The satellite defined in claim 1, wherein at least two ITUs of the at least two ITUs are arranged to provide thrust that is aligned with a central axis of the satellite.

11. The satellite defined in claim 1, wherein an ITU of the at least two ITUs is not aligned with a central axis of the satellite.

12. The satellite defined in claim 1, further comprising a control system to selectively activate each ITU independent of another ITU based on one or more inputs.

13. The satellite defined in claim 12, wherein the control system is configured to selectively activate two or more ITUs to compensate for drag and to simultaneously create attitude compensating torque.

14. The satellite of claim 1, wherein the thrust of at least one of the at least two ITUs providing attitude control includes a component of drag compensation.

15. The satellite defined in claim 1, wherein a total thrust of the array of at least two ITUs is greater than or equal to a total thrust required for drag compensation.

16. The satellite defined in claim 15, wherein the total thrust is equal to or greater than the thrust to compensate for drag. (need to tweak up wording)16.

17. The satellite defined in claim 16, wherein the one or more inputs include a direction, a speed, an attitude, an altitude, or a change thereof.

18. The satellite defined in claim 16, wherein the control system is configured to control a frequency or a magnitude of impulse bits for each ITU.

19. The satellite defined in claim 1, further comprising one or more additional ITUs arranged on a top, bottom, or lateral side of a body of the satellite.

20. The satellite defined in claim 1, wherein the satellite is configured to operate at an altitude of 180-350 km.

21. The satellite defined in claim 1, further comprising one or more moveable control surfaces configured to adjust a position relative to the satellite based on forces from particle collisions, each moveable control surface configured for independently controlled movement.

22. A satellite attitude and drag control system comprising:
a plurality of individual thruster units (ITUs) arranged in an array, each ITU configured for independently controlled firing, wherein the plurality of ITUs comprises one or more attitude correcting ITUs and one or more drag compensating ITUs, such that the one or more attitude correcting ITUs correspond to one or more of the drag compensating ITUs; and
one or more stabilization surfaces aligned with a direction of motion of the satellite.

23. The satellite attitude or drag control system defined in claim 22, wherein the one or more attitude correcting ITUs correspond to a proper subset of the one or more drag compensating ITUs.

24. The satellite attitude or drag control system defined in claim 22, further comprising a control circuitry configured to control an ITU of the plurality of ITUs to fire, wherein thrust from firing an ITU of the plurality of ITUs to compensate for drag is simultaneously effective to compensate for attitude.

25. The satellite attitude or drag control system defined in claim 24, wherein the control circuitry is further configured to control the ITU for additional firing to correct for attitude in addition to ITUs required to compensate for drag.

26. The satellite attitude or drag control system defined in claim 24, wherein thrust to compensate for drag fully compensates for attitude.

27. The satellite attitude or drag control system defined in claim 22, further comprising a control circuitry configured to control an ITU of the plurality of ITUs to fire, wherein thrust from firing an ITU of the plurality of ITUs to compensate for attitude is simultaneously effective to compensate for drag.

28. The satellite attitude or drag control system defined in claim 22, wherein each ITUs is configured for controlled firing to generate impulse bits and a firing frequency to provide attitude control.

29. The satellite attitude or drag control system defined in claim 22, wherein the plurality of ITUs are configured to fire to provide attitude control at low angles of attack within a range of angles of attack, such that aerodynamic forces provide greater attitude stability at large angles of attack of the range of angles of attack, both of which can combine to provide attitude control of the spacecraft.

30. The satellite attitude or drag control system defined in claim 22, wherein control system is configured to control roll, pitch, or yaw, and total thrust.

31. The satellite attitude or drag control system defined in claim 22, further comprising a control circuitry to:
receive one or more inputs from one or more sensors associated with forces acting on the satellite associated with drag or changes in attitude of the satellite;
determine an amount of attitude-compensating torque needed to compensate for the drag or the changes in attitude;
selectively control movement of one or more moveable control surfaces based at least in part on the determined amount of attitude-compensating torque; and
selectively activate one or more ITUs based at least in part on the determined amount of attitude-compensating torque.

32. The satellite attitude or drag control system defined in claim 22, wherein the satellite is configured to operate at an altitude of 180-350 km.

33. The satellite attitude or drag control system defined in claim 22, wherein the center of mass of the satellite is closer to a leading edge of the satellite than a center of aerodynamic force of the satellite.

34. The satellite attitude or drag control system defined in claim 22, wherein one or more surfaces are arranged symmetrically along a body of the satellite

35. The satellite attitude or drag control system defined in claim 22, wherein at least one ITU comprises at least one of the following: ionic, chemical, mechanical, electrical, or metal plasma.

36. A satellite operating at an altitude of 180-350 km comprising:
a plurality of individual thruster units (ITUs), the ITUs being configured for controlled firing to provide attitude control and drag compensation, wherein at least two ITUs of the plurality of ITUs are arranged in an array; and
a control circuitry to:
receive one or more inputs from one or more sensors associated with forces acting on the satellite associated with drag or changes in attitude of the satellite;
determine an amount of attitude-compensating torque needed to compensate for the drag or the changes in attitude;
selectively control movement of one or more moveable control surfaces based at least in part on the determined amount of attitude-compensating torque; and
selectively activate one or more ITUs based at least in part on the determined amount of attitude-compensating torque.
